(19) United States
(12) Patent Application Publication
(10) Pub. No.: US 2021/0337645 A1
(43) Pub. Date: Oct. 28, 2021

(54) METHOD AND ADJUSTMENT SYSTEM FOR ADJUSTING SUPPLY POWERS FOR SOURCES OF ARTIFICIAL LIGHT

(71) Applicants: Paul OSINGA, Son en Breugel (NL); Jules DE LAAT, Tilburg (NL)

(72) Inventors: Paul OSINGA, Son en Breugel (NL); Jules DE LAAT, Tilburg (NL)

(73) Assignee: KONINKLIJKE PHILIPS ELECTRONICS N.V., Eindhoven (NL)

(21) Appl. No.: 13/386,450

(22) PCT Filed: Jul. 19, 2010
(86) PCT No.: PCT/IB2010/053268

§ 371 Date: Dec. 27, 2012

(30) Foreign Application Priority Data
Jul. 24, 2009 (EP) 09166312.0

(51) Int. Cl. H05B 47/11

(52) U.S. Cl. CPC H05B 47/11

(57) ABSTRACT

The invention describes a method for adjusting supply powers for a first source of artificial light (5, 5′, 5″, 5′″) in a first zone (W) of a room (1) and of a number of second sources of artificial light (9, 9′, 9″, 9′″, 11, 11′, 11″, 11′″) in a number of second zones (K₁, K₂) of the room (1). Thereby, the first zone (W) is closer to an external light source (3, 3′, 3″, 3′″) than the second zones (K₁, K₂), and the supply powers for the first and second sources of artificial light (5, 5′, 5″, 5′″, 9, 9′, 9″, 9′″, 11, 11′, 11″, 11′″) are reduced when a level of combined light level (P_{Comb}), comprising light (L₁) from the first source of artificial light (5, 5′, 5″, 5′″) and light (Lₑ) from the external light source (3, 3′, 3″, 3′″), increases. The method comprises at least the steps of measuring (X) a level of combined light (P_{Comb}), deriving (Y) in a closed loop circuit from the measured level of combined light (P_{Comb}) first B N A supply power control signals (VCS₁) for driving the first source of artificial light (5, 5′, 5″, 5′″), deriving (Z) from the first supply power control signals (VCS₁) second power control signals (VCS₂) for driving the second sources of artificial light (9, 9′, 9″, 9′″, 11, 11′, 11″, 11′″). Furthermore, the invention concerns an adjustment system (23) for the same end.

### FIELD OF THE INVENTION

The invention concerns a method for adjusting supply powers for a first source of artificial light in a first zone of a room and of a number of second sources of artificial light in a number of second zones of the room. Thereby, the first zone is closer to an external light source such as the daylight (the external light source being e. g. a window through which the daylight enters the room) than the second zones. The adjustment is dependent on a light input by the external light source. In addition, the invention concerns an adjustment system for such purpose.

### BACKGROUND OF THE INVENTION

Depending on the time of the day and on the weather, the lighting situation in a room differs substantially even during daytime. Fixed artificial lighting can equalize lack of incoming daylight, but is energy-consuming. In addition, as for larger rooms, the need for artificial lighting substantially differs in different zones of such rooms. One can basically divide larger rooms in a first zone, a so-called window zone, and second zones, so-called corridor zones, as indicated above. It is apparent that the lighting situation in the window zone is very different from that in the corridor zones.

To achieve a suitable light level throughout such room, artificial light sources in the second zones must shine brighter than those in the first zone. One can accomplish this by manually regulating the light levels e.g. with the help of dimmers. In order to achieve the same or an even improved effectiveness, automatic so-called “daylight harvesting” systems have been introduced. For example, US 2006/0279225 A1 discloses such daylight harvesting system in which a photocell measures ambient light in a room, i.e. light that comes from an external light source or from any of the artificial light sources in the room. These artificial light sources which are positioned in different zones of the room are supplied with different levels of electric power The term “adjustment of supply power” is used throughout this application for a variation of electric power supply to sources of artificial light, be it through a variation of voltage or through other means such as a variation of frequency, a variation of current or any other variation which results in different light outputs by the artificial light source to which this variation is applied.

For such system, it is necessary to base the control of power output on a certain rule, e.g. a rule that derives from the level of measured light the level of power output to all the artificial light sources at different rates. It is evident that measurement of ambient light by using just one single photocell implies a certain reduced accuracy because the photocell must be positioned and orientated in such way that its measurement covers an average light level. The use of more photocells would be more accurate but at the same time implies that more material is used, that a bigger computing capacity of the controlling circuits is needed and thus, that the whole system becomes more costly.

It is thus the object of the present invention to further enhance such systems by providing an effective possibility for adjustment of supply powers as an alternative to existing systems.

### SUMMARY OF THE INVENTION

To this end, the present invention describes a method for adjusting supply powers for a first source of artificial light in a first zone of a room and of a number of second sources of artificial light in a number of second zones of the room, the first zone being closer to an external light source than the second zones, whereby the supply powers for the first and second source of artificial light are reduced when a level of combined light, comprising light from the first source of artificial light and light from the external light source, increases, the method comprising at least the following steps:

a) measuring the level of combined light,

b) deriving—in a closed loop circuit—from the measured level of combined light first supply power control signals for driving the first source of artificial light,

c) deriving from the first supply power control signals second power control signals for driving the second sources of artificial light.

In the context of the invention, the expression “a number of” includes both a single item or a multitude of items. Therefore, a number of second sources of artificial light may comprise one or several light sources, just as well as a number of second zones may be one or more second zone(s). It must further be noted that one source of artificial light may comprise several sub-sources such is the case with LED lamps, for example. One single source of artificial light is therefore defined to be one or several sub-sources which are positioned in the same zone, i.e. a particular second zone or the first zone which are attached to one single control unit. A zone is thereby defined by its distance to an external light source, whereby an “external light source” in the context of this application is not necessarily the point of origin of the external light but rather the installation in the room through which the external light enters the room, such as a window or a lightwell. This distance may vary to a certain extent, i.e. within a range of 10 m, preferably less than 5 m. Another possible definition is that the room is divided in at least two, preferably more zones which are essentially equal in their extension between a wall in which there is an external light source, and another wall facing that firstly mentioned wall. Most commonly, the light from the external light source would be daylight, i.e. light coming directly or indirectly (as diffuse light) from the sun, but the external light source may also be fed by other means such as streetlamps etc. The first zone of the room may also be labelled a window zone due to its closer proximity to the light source which is often a window. In contrast, the second zones may also be labelled corridor zones as they are often closer to a corridor than the window zone. The first and second light sources are thus assigned accordingly to the first and second zones of the room.

Unlike in the state of the art, where a level of ambient light in the room is measured, the method according to the invention includes the measurement of so-called combined light. Such combined light comprises both light from the first source of artificial light and from the external light source, whereby it needs to be stressed that both these sources can either contribute no or virtually all the amount of light measured or a mixture in between. “Combined light” is preferably such light in which the percentage of influence by the second sources of artificial light can be considered negligible. Such is the case if the percentage of light from the second sources of artificial light makes up for less than 20%, preferably less than 10%, most preferred less than 5% of the light measured when essentially no light from the external light source can be detected, i.e. e.g. at night time.

Such difference between “ambient light” and “combined light” may seem minute, but can result in a completely different outcome of the method: the measurement of combined light focuses mainly on those two light sources mentioned, while measurement of “ambient light” usually includes measurement of light from all kinds of light sources. Therefore, there is a clear focus to measure a lighting situation in the first zone of the room.

This first zone can be considered the centre of attention of the invention, because the lighting situation in this zone is of particularly high importance, because the energy-saving potential in this zone is highest. This can be explained by the direct influence of incoming external light into the first zone which can be used directly to reduce artificial light output in this zone. Apart from that, in smaller rooms one would often put desks nearby windows or similar sources of external light in order to use as much external light as possible. In contrast, in the second zones of such rooms, one would rather put shelves and other storage means which implies that these zones are not as frequently used as the first zone and therefore that providing an exact light level is not as necessary as in the first zone. In general, by means of a clear focus on the first zone, the method according to invention makes sure that a minimum of energy consumption is necessary, thus making possible a maximum of energy-saving and therefore cost-effectiveness.

The invention therefore uses the measurement data of the measurement of combined light in order derive first supply power control signals which are used to drive the first source of artificial light. In other words use is made of a closed loop control circuit for the first zone, taking into account the impact of light from the first source of artificial light in order to control the output of this very source of light. This ensures an instant reaction of the system once the lighting situation changes in the first zone. From these first supply power control signals the second supply power control signals are derived for the second sources of artificial light. That means that there is a hierarchy of control signals, whereby the first power control signals are based directly on the measurement whilst the second power control signals are only indirectly derived from the measurement via the “detour” over the first power control signals. Thus, the method according to the invention increases efficiency of lighting, in particular in the first zone, while at the same time the extra expenses are considerably low, if existent at all.

The method according to the invention may also be realized by means of an adjustment system comprising at least the following:

a) a photo detection unit realized and/or positioned such that it measures a level of combined light,

b) a first control circuit realized to derive from the measured level of combined light first supply power control signals for driving the first source of artificial light,

c) at least a second control circuit realized to derive from the first supply power control signals additional power control signals for driving the additional sources of artificial light.

The photo detection unit, for example a photocell or a detection unit based a CCD chip, is preferably orientated towards the first zone in order to measure such combined light as mentioned above. For that purpose it is positioned and directed in an according way.

The first and second control circuits may be realized as single control units or within a combined control unit, for example as organizational units on a processor. They may be integrated within the photo detection unit or be realized as separate circuits in communication with one another and with the photo detection unit. Also, there may be several combined control units communicating with one another and with the photo detection unit. The photo detection unit and the first control circuit are part of the closed loop circuit which measures the combined light and therefrom derives the first power control signals for the first source of artificial light which, again, contributes to the combined light. Each control circuit may be realized in the form of hardware or in software as well as in a combination thereof. Such combined control circuit and/or the control elements comprise interfaces towards the according source of artificial light and/or a power supply unit and towards the photo detection unit and/or the other control circuit(s).

The adjustment system according to the invention can thus be used to carry out a method according to the invention. The first and the additional control circuits represent and are used to carry out the steps b) and c) of the method.

The invention also concerns a lighting system for a room with a first source of artificial light in a first zone and with a number of second sources of artificial light in a number of second zones, the first zone being closer to an external light source than the second zones, further comprising an adjustment system according to the invention.

The dependent claims and the subsequent description disclose particularly advantageous embodiments and features of the invention.

In a preferred embodiment of the method according to the invention the supply power for the first source of artificial light is reduced at least up until a pre-defined cut-off threshold of the level of external light and in the cut-off region from that cut-off threshold onwards the supply powers for the second sources of artificial light are adjusted in direct dependence on the measured level of combined light.

Such pre-defined cut-off threshold thus defines a cut-off zone in which the lighting power of the first source of artificial light is at a very low level or has the value 0. A very low level can be defined at 5% of lighting power or below the nominal power of the first source of artificial light. In this cut-off zone, the first source of artificial light provides for (virtually) no lighting in the room and one can assume that the main part of the measured combined light comes from the external light source.

This embodiment is thus based on the assumption that in the cut-off zone the first supply power control signals for driving the first source of artificial light cannot be effectively used as a basis for deriving the second supply power control signals for driving the second sources of artificial light. It can rather be assumed that the first supply power control signals are constant in the cut-off zone, because light from the external light source makes up for the greatest part of the combined light, whereas the first source of artificial light is either at a very low constant level or completely switched off. Therefore, in contrast to a first regulation mode which was described above, an additional logic for driving the second sources of artificial light according to a second regulation mode is needed, which is in this case a so-called “open loop” control circuit based on the measurement of combined light, which is in fact an approximate measurement of light input by the external light source. This way a valid basis for generating second supply power control signals for the second sources of artificial light is used even for the cut-off zone.

Furthermore, it has been proven advantageous, that the second power control signals are such that the supply powers for the second sources of artificial light are equal or higher than the supply power for the first source of artificial light. This way—based on the assumption that both the first and the second sources of artificial light have the same (nominal) rating—it is assured that the artificial light sources in those zones (i.e. the second zones) with less light input from the external light source have a higher power output and therefore provide more artificial light to compensate the lesser amount of external light in these zones.

In this context it is particularly preferred that the first and second power control signals are such that the supply powers of the first and second sources of artificial light are at a maximum in a situation in which the light input by the external light source is less than a pre-defined minimum threshold.

It is further preferred that the first and second power control signals are such that the supply powers of the first and second sources of artificial light are reduced at an equal rate up until a pre-defined second threshold of light input by the external light source and/or of the supply power of the first source of artificial light, and are reduced at different rates from that second threshold on.

Both preferred embodiments mentioned above which can be used solely or in combination imply that there is installed a stepwise logic of the second power control signals with respect to the first power control signals. This is due to the following influences: When there is no or very little light input by the external light source, for example at night time, this influence is negligible and therefore the power output by the first and second sources of artificial light must be at its highest. The minimum threshold is chosen such that the light input by the external light source is still a minor contribution, i.e. a negligible percentage (e.g. less than 5 to 10%), to the combined light. Therefore, from a situation of no light input by the external light source up to the minimum threshold all sources of artificial light adjusted by the adjustment system are run at full power to cater for sufficient lighting in the room.

Either from complete darkness or from the minimum threshold onwards to a second threshold, the power supply of the first and second sources of artificial lights is reduced equally with an increase of external light. This second threshold is defined by the effect of an overdimensioning of the lighting system. This results from the fact that the overall light output of all sources of artificial light is usually chosen such that it exceeds the need for lighting in a room. This is due to the fact that lamps are only available at certain nominal power output values and because there is a certain ageing effect of lamps which has to be considered beforehand when planning the layout of a lighting system in a room. As a reduction of light at a common reduction rate for these sources of artificial light is the easiest way to reduce light output and because energy can be saved with such logic, this logic is chosen within the range of the overdimensioning of the lighting system. From that second threshold onwards, the regulation logic changes to a different reduction of power supply to the sources of artificial light in the different zones in order to differentiate more precisely between these zones and their need for lighting.

According to a preferred embodiment of the invention, the second power control signals are such that the supply powers for the second sources of artificial light have an increasing offset from the supply power for the first source of artificial light, the more light input by the external light source is detected, at least from a pre-defined threshold onwards. An offset is defined as the difference of supply power values between the supply power of the second sources of artificial light and the supply power of the first source of artificial light. This difference increases with the reduction of the supply power of the first source of artificial light. This is due to the fact that light impact of the external light source in the first zone will be much stronger than in the second zones. Therefore, the reduction of light output by the second sources of artificial light needs to be gentler than that of the first source of artificial light in order to compensate.

The invention can be realized using a multitude of light sensors that measure the combined light. However, it is preferred that the combined light level is measured by a single photo detection unit. One single such light sensor is fully sufficient for the method according to the invention, which means that equipment can be saved and the adjustment system can be made as effective as possible using such mode.

To make sure that the light measured is indeed combined light according to the definition given above, the photo detection unit can be directed at a point within the first zone. Most preferred, the photo detection unit is positioned within the first zone. According to an even further advancement, the photo detection unit is positioned at a substantially equal distance as the distance of the first source of artificial light source from the external light source. This way it can be assured that the combined light measured by the light sensor corresponds directly with the light output of the first source of artificial light, which would usually be positioned in such way that a person who works in the room will have its full effect when there is no light from the external light source present.

### BRIEF DESCRIPTION OF THE DRAWINGS

FIG. 1 shows a schematic projectional view into a room from above with elements of a lighting system according to the invention.

FIG. 2 shows a first graph depicting the light output scheme of two artificial light sources in dependence of light input into the room according to a preferred embodiment of the invention.

FIG. 3 shows two combined graphs showing the division between lighting provided by two artificial light sources and an external light source which occurs in the context of the same embodiment of the invention as in FIG. 2.

FIG. 4 shows a schematic block drawing of a lighting system with an embodiment of an adjustment system according to the invention.

FIG. 5 shows a schematic block diagram of the steps of a method according to an embodiment of the invention.

In the drawings, like numbers refer to like objects throughout. Objects are not necessarily drawn to scale.

### DETAILED DESCRIPTION OF THE EMBODIMENTS

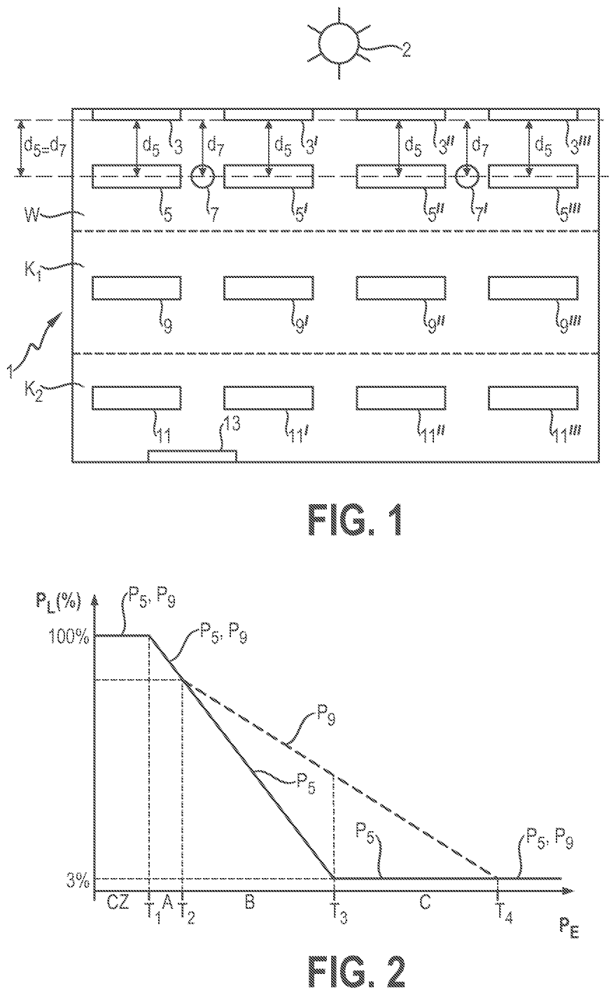

FIG. 1 shows schematically a room 1 with external light sources 3, 3′, 3″, 3′″ realized as windows through which daylight, symbolized by the sun 2, can enter the room 1. On the wall facing the wall with the windows 3, 3′, 3″, 3′″, there is a door 13 leading into a corridor. Accordingly, three zones of the room are labelled the first zone or window zone W which is closest to the windows 3, 3′, 3″, 3′″ and two second zones or corridor zones K₁, K₂, which are further away from the windows 3, 3′, 3″, 3′″ and closer to the corridor. All zones W, K₁, K₂ have the same dimensions here. However, the definition of the first and second zones W, K₁, K₂ can also be different, depending mainly on the overall lighting situation of the room 1. For example, a room to be lighted may have a different shape than a purely rectangular one. It may have recesses where little external light comes in although they may be at a close proximity of windows. Therefore, a first zone can be generally defined as that zone which is lit by direct light from an external light source at least some time of the day. A second zone is a freely definable zone outside the first zone. There may be defined several second zones or just one.

In each zone W, K₁, K₂ there are sources of artificial light 5, 5′, 5″, 5′″, 9, 9′, 9″, 9′″, 11, 11′, 11″, 11′″. First sources of artificial light 5, 5′, 5″, 5′″ are positioned in the first zone W, second sources 9, 9′, 9″, 9′″ are positioned in the second zone K₁ closer to the first zone W and other second sources 11, 11′, 11″, 11′″ are positioned in the second corridor zone K₂ further away from the first zone W. Within the first zone W there are also photo detection units 7, 7′. The first sources of artificial light 5, 5′, 5″, 5′″ are at a distance d₅ from the windows 3, 3′, 3″, 3′″ which is the same distance as distance d₇ measured from the photo detection units 7, 7′ in the same measuring direction.

In order to supply sufficient lighting for the room 1 at all times—be it night or daytime—and under all weather conditions, whilst trying to waste as little lighting energy as possible, it is necessary to regulate the supply powers for the first and second sources of artificial light 5, 5′, 5″, 5′″, 9, 9′, 9″, 9′″, 11, 11′, 11″, 11′″ in dependence on the light input from the external light sources 3, 3′, 3″, 3′″. In particular, a very precise lighting is necessary in the first zone W, which is influenced strongest by quick lighting changes of the external light sources 3, 3′, 3″, 3′″ and at the same time needs most of the attention because persons working in the room 1 will typically be situated in the first zone W, i.e. in close proximity of the windows 3, 3′, 3″, 3′″.

In FIG. 2 there is depicted the light power output P_{L} (which may be measured in lumen) in % of nominal light power output of one of the first sources of artificial light 5 of FIG. 1 and of one of the second sources of artificial light 9 of FIG. 1. For the sake of clarity, the light power output of a second source of artificial light 11 in the second corridor zone K₂ is left out, but the line can be considered similar to that of the second source of artificial light 9 with an even larger offset.

The light power output P_{L} is depicted over a measured light power input P_{E} (in arbitrary units) of the external light sources 3, 3′, 3″, 3′″. The first source of artificial light 5 has a light power output curve P₅, while the second source of artificial light 9 has a light power output curve P₉. The maximum of possible light power output of both sources of artificial light 5, 9 is considered to be 100%. As can be seen, in a mode CZ of low external light power input from 0 up to a minimum threshold T₁ both light power output curves P₅, P₉ are constantly at 100%. In a mode A from the minimum threshold T₁ up to a second threshold T₂ their light power output P_{L} is reduced at the same rate. The second threshold T₂ can be chosen depending on two different values, i.e. either on a certain value of light power input P_{E} of the external light sources 3, 3′, 3″, 3′″ or on a certain value of the light power output curve P₅. The reduction of light power output P_{L} at the same rate is due to the fact, that the 100% of light power output P_{L} are above the power that is needed to light the room 1 sufficiently and therefore the reduction of light power output P_{L} at the same rate does not reduce the overall lighting situation in a way that affects persons in the room 1. However, in a mode B between the second threshold T₂ and a third threshold T₃, the values of light power output P_{L} begin to differ. There is an increasing offset of the curve P₉ with respect to the curve P₅. The third threshold T₃ can be considered a cut-off threshold which means that the light power output P_{L} of the first source of artificial light 5 has reached a minimum dimming level of below 5%, here 3%. In mode C, i.e. from the cut-off threshold onwards, the second source of artificial light 9 has to be controlled independently from the first source of artificial light 5 because no valid input data can be derived from curve P₅.

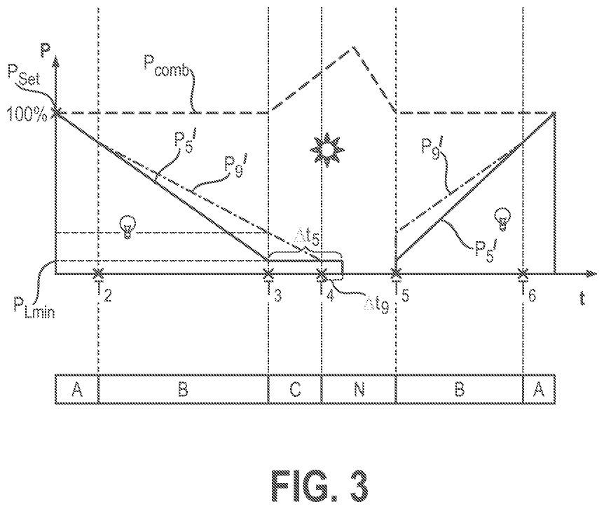

This effect becomes more apparent when looking at FIG. 3. It is a level of light P (in % of a desired minimum level of light P_{Set} in the first zone W) over time t (with no particular scale given), whereby the complete time range of the diagram covers a timespan from sunrise to sundown on a cloudless day. There are shown light power output curves P₅′, P₉′. The diagram takes out of account the mode CZ which was shown in FIG. 2. Based on the assumption that the level of combined light P_{comb} is made up of daylight—symbolized by the sun—and of artificial light—symbolized by a lamp, it is to be made sure that this level of combined light P_{comb} is at least at 100% of the desired minimum level of light P_{Set}. In a mode A, both curves P₅′, P₉′ follow exactly the same scheme, i.e. the light power outputs of the first and second sources of artificial light 5, 9 are reduced at the same rate.

After the second threshold T₂, this rate changes, and as in FIG. 2, an increasing offset can be observed during mode B. At the third threshold T₃, the first source of artificial light 5 has reached the minimum dimming level P_{Lmin} and is kept at that level for a switch-off delay time Δt₅.

Up until the third threshold T₃, the level combined light P_{comb} has been a combination of daylight and of light from the first source of artificial light 5. From that point onwards, which can be considered around midday, when the influence of sunlight is at its highest on a cloudless day, i.e. in mode C, the level combined light P_{comb} increases above 100% of the of the desired minimum level of light P_{Set} because the daylight alone caters for more than the desired minimum level of light P_{Set}.

In mode C, the lighting power of the second source of artificial light 9 is adjusted in direct dependence on the measured combined light P_{comb}. This change of adjustment method means a change from a control method based on the control of the first source of artificial light 5, into an open-loop situation. A fourth threshold T₄ is reached when the power output curve P₉′ has also reached its minimum dimming level P_{Lmin}, which signifies that no lighting in the second zone K₁ is necessary any more. This means that after a switch-off delay Δt₉ the second source of artificial light is also completely switched off. This second switch-off delay Δt₉ may be such that the endpoint coincides with the switch-off of the first source of artificial light 5, but not necessarily. From the fourth threshold T₄, a regulation mode N is applied which basically means that lighting power of both the first and the second sources of artificial light 5, 9 is not needed for lighting the room.

When the lighting power of daylight is reduced, there is a fifth threshold T₅ at which both sources of artificial light 5, 9 are switched on again with the same level of light output as at the third threshold T₃, i.e. in regulation mode B. It may be noted that the diagram of FIG. 3 shows the development over time during an exemplary day with certain ideal preassumptions. Therefore, all thresholds can also occur at different times than shown here. Their occurrence is not defined by time, but by the values of the measurement of the combined light input P_{comb}. At a last threshold T₆ the two curves P₅′, P₉′ unite again into a single line according to the rules of regulation mode A.

Thus, there are four logics applied in this system: In mode A up to second threshold T₂ and from sixth threshold T₆ onwards, the light power output of both sources of artificial light 5, 9 are regulated to be equal. In mode B from the second threshold T₂ to the third threshold T₃ and from the fifth threshold T₅ to the sixth threshold T₆, there is an offset of the two curves P₅′, P₉′. In mode C from the third threshold T₃ to the fourth threshold T₄ the light power output of the second source of artificial light 9 is dependent on the measured level combined light P_{comb}, which is in effect the level of light input by the sun 2. Mode N is essentially a switch-off mode in which both sources of artificial light are ruled down to a minimum or no output (e.g. after a time delay as shown in FIG. 3).

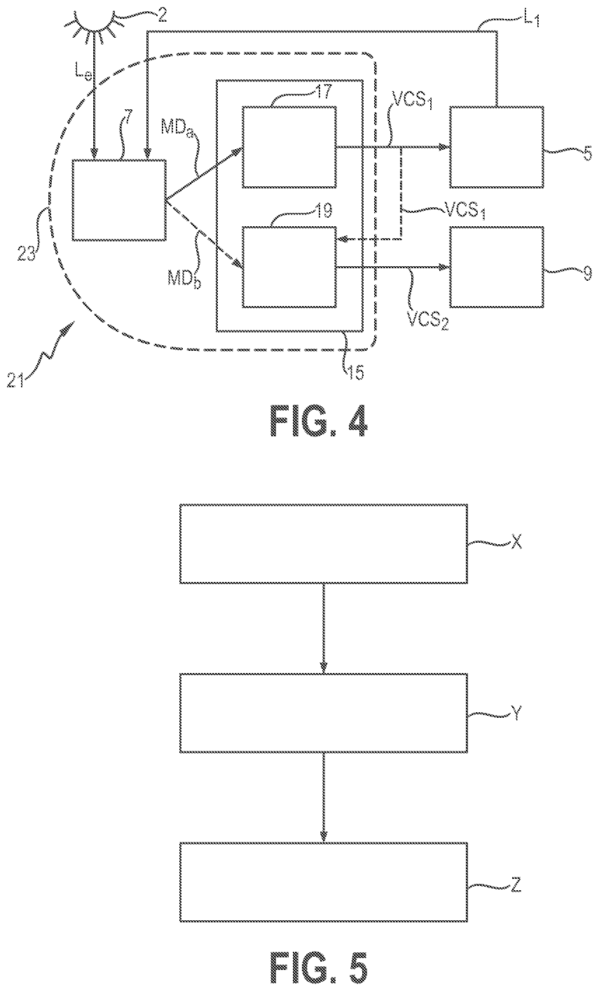

FIG. 4 shows schematically a lighting system 21 comprising a first source of artificial light 5 and a second source of artificial light 9 in accordance with the previous figures. In addition, it comprises an adjustment system 23 according to an embodiment of the present invention. The adjustment system 23 comprises a photo detection unit 7 and a control unit 15 with two control circuits 17, 19.

The photo detection unit 7 measures the level of combined light as explained with reference to FIG. 1, which is made up of light L₁ from the first source of artificial light 5 and of light Lₑ from an external light source, symbolized by the sun 2. First measurement data MDₐ are received by the first control circuit 17 which derives from them first supply power control signals VCS₁ for controlling the first source of artificial light 5. A closed loop circuit is created from the photo detection unit 7, the first control circuit 17 and the first source of artificial light 5 back to the photo detection unit 7.

From the first supply power control signals VCS₁ the second control circuit 19 derives second supply power control signals VCS₂ for controlling the second source of artificial light 9. Once the first supply power control signals VCS₁ are such that the first source of artificial light 5 is sending out no light or light below a cut-off value, a second logic starts in which second measurement data MD_{b} from the photo detection unit Tare directly forwarded to the second control element 19 which derives therefrom its second supply power control signals VCS₂ instead of from the first supply power control signals VCS₁. It can be observed that the second logic (which is according to mode C in FIGS. 2 and 3) is based on an open loop control circuit, because the light output of the second source of artificial light 9 is directly dependent on the measured level of combined light P_{comb} which is essentially the level of external light input.

FIG. 5 shows a schematic block diagram of a method according to an embodiment of the invention. In the context of a room 1 as shown in FIG. 1 and with reference to all previous figures, the method comprises within mode B (compare FIGS. 2 and 3) a step X in which is measured a level of combined light. In step Y there are derived from that measurement first supply power control signals VCS₁ and in a step Z from these first supply power control signals VCS₁ there are derived second supply power control signals VCS₂. This way the curves P₅, P₅′, P₉, P₉′ as shown in the mode B in FIGS. 2 and 3 are realized.

Although the present invention has been disclosed in the form of a number of preferred embodiments, it is to be understood that additional modifications or variations could be made to the described embodiments without departing from the scope of the invention. For example, the control unit may be altered in many ways as well as the arrangement of artificial light sources.

For the sake of clarity, it is to be understood that the use of “a” or “an” throughout this application does not exclude a plurality, and “comprising” does not exclude other steps or elements. A “unit” can comprise a number of units, unless otherwise stated.

1. Method for adjusting supply powers for a first source of artificial light in a first zone of a room and of a number of second sources of artificial light in a number of second zones of the room, the first zone being closer to an external light source than the second zones, whereby the supply powers for the first and second sources of artificial light are reduced when a level of combined light, comprising light from the first source of artificial light and light from the external light source, increases, the method comprising at least the following steps:
a) measuring the level of combined light,
b) deriving from the measured level of combined light first supply power control signals for driving the first source of artificial light,
c) deriving from the first supply power control signals second power control signals for driving the second sources of artificial light.

2. Method according to claim 1, wherein the supply power for the first source of artificial light is reduced at least up until a pre-defined cut-off threshold of the level of external light and in the cut-off region from that cut-off threshold onwards the supply powers for the second sources of artificial light are adjusted in direct dependence on the measured level of combined light.

3. Method according to claim 1, wherein the second power control signals are such that the supply powers for the second sources of artificial light are equal or higher than the supply power for the first source of artificial light.

4. Method according to claim 3, wherein the first and second power control signals are such that the supply powers of the first and second sources of artificial light are at a maximum in a situation in which the light input by the external light source is less than a pre-defined minimum threshold.

5. Method according to claim 3, wherein the first and second power control signals are such that the supply powers of the first and second sources of artificial light are reduced at an equal rate up until a pre-defined second threshold of light input by the external light source and/or of the supply power of the first source of artificial light, and are reduced at different rates from that second threshold on.

6. Method according to claim 3, wherein the second power control signals are such that the supply powers for the second sources of artificial light have an increasing offset from the supply power for the first source of artificial light the more light input by the external light source is detected, at least from a pre-defined threshold onwards.

7. Method according to claim 1, wherein the combined light level is measured by a single photo detection unit.

8. Method according to claim 7, wherein the photo detection unit is positioned within the first zone.

9. Method according to claim 8, wherein the photo detection unit is positioned at a substantially equal distance as the distance of the first source of artificial light from the external light source.

10. Adjustment system for adjusting supply powers for a first source of artificial light in a first zone of a room and for a number of second sources of artificial light in a number of second zones of the room, the first zone being closer to an external light source than the second zones, whereby the supply powers for the first and second sources of artificial light are reduced when a level of combined light level, comprising light from the first source of artificial light and light from the external light source, increases the system comprising at least the following:
a) a photo detection unit realized and/or positioned such that it measures the level of combined light,
b) a first control circuit realized to derive from the measured level of combined light first supply power control signals for driving the first source of artificial light,
c) at least a second control circuit realized to derive from the first supply power control signals second power control signals for driving the second sources of artificial light.

11. Lighting system for a room with a first source of artificial light in a first zone and with a number of second sources of artificial light in a number of second zones, the first zone being closer to an external light source than the second zones, further comprising an adjustment system according to claim 10.
